(19) United States
(12) Patent Application Publication
(10) Pub. No.: US 2017/0152837 A1
(43) Pub. Date: Jun. 1, 2017

(54) PORTABLE POWER GENERATING SOLAR CELL WIND TURBINE

(71) Applicant: Design, Research and Analysis Corporation, Lawrence, KS (US)

(72) Inventors: Willem Anemaat, Lawrence, KS (US); Wanbo Liu, Lawrence, KS (US); Brandon Basgall, Lawrence, KS (US)

(73) Assignee: Design, Research and Analysis Corporation, Lawrence, KS (US)

(21) Appl. No.: 15/364,777

(22) Filed: Nov. 30, 2016

Related U.S. Application Data
(60) Provisional application No. 62/260,713, filed on Nov. 30, 2015.

(51) Int. Cl. F03D 9/00; H02S 10/12; F03D 80/80

(52) U.S. Cl. CPC F03D 9/007; F03D 80/82; H02S 10/12

(57) ABSTRACT

Electrical power may be generated from wind and/or solar inputs. A plurality of rotor blades may extend radially from a rotor hub. The rotor blades may rotate about the rotor hub under the influence of an incident wind to produce an electrical current from a generator retained within a nacelle. Photovoltaic films may cover at least a portion of the surfaces of the rotor blades. The rotor blades may be detachable from the rotor hub for use in a solar panel arrangement. The rotor blades may be folded to enclose the nacelle for transporting the system.

### CROSS-REFERENCE TO RELATED APPLICATIONS

This application claims the benefit of provisional patent application Ser. No. 62/260,713, entitled “Portable Power Generating Solar Cell Wind Turbine,” filed on Nov. 30, 2015, which is incorporated herein by reference.

### FIELD OF INVENTION

The present invention relates to the generation of electrical energy. More particularly, the present invention relates to systems and methods for generating electrical energy using a combined solar powered photovoltaic and wind turbine system.

### BACKGROUND AND DESCRIPTION OF THE RELATED ART

Onsite energy generation through renewable sources may be preferable to obtaining energy through means such as power lines, fuel, batteries, fuel cells, or other sources requiring infrastructure installation or reliant upon finite repositories of energy. For example, some locations may be remote from human energy infrastructure and/or difficult to access. In some instances, humans may occupy a location for only relatively short periods of time, making large-scale energy infrastructure impractical for the anticipated needs. In other cases, disasters or failures may temporarily disrupt energy resources, creating the need for some amount of power generation onsite—which may require transporting generating capacity to a location.

In some instances, renewable power generation may supplement more conventional power sources. For example, batteries or fuel cells may be recharged using renewable power, or renewable power may be used while available with other power supplies when renewable power is unavailable or inadequate to meet the power demands of a human activity at a location. In other instances, power may be needed only intermittently and/or lightly, making small-scale renewable electricity generation desirable. In other examples, renewable power sources, even with a relatively small generating capacity, may be adequate for human use at a location for a small number of individuals and/or for individuals with limited power needs.

### SUMMARY OF THE INVENTION

The present invention provides systems and methods that generate electrical power using wind and/or solar energy. Systems in accordance with the present invention may be configurable to permit easy transportation and deployment. By providing multiple ways to generate electrical power, the present invention may be used to provide electrical power under most environments encountered on Earth. In accordance with the present invention, rotor blades of a wind turbine may incorporate photovoltaic materials, such as a photovoltaic film, on all or part of their surfaces. By combining wind generation and solar generation of electrical power, systems in accordance with the present invention may provide at least two sources of power. The present invention may provide power from both sources (wind and solar) simultaneously using a regulator or charge controller to combine the electrical current produced through the different sources, but may also operate to generate power from only a single source at a time.

In some examples, a system in accordance with the present invention may be deployed in different configurations for different power generation scenarios and/or for transport. For example, to generate power from wind energy, rotor blades may be radially affixed to a rotor hub on a nacelle to present the rotor blades in a substantially vertical configuration to form an operable turbine. In such a turbine configuration, the photovoltaic surfaces may generate electrical current from sunlight incident upon them, though the configuration would not typically optimize the generation of electrical power from the sunlight. In another configuration, to generate power from solar energy the rotor blades may be configured to present a surface substantially perpendicular to incident sunlight, which will almost always be in a non-vertical arrangement. Such an arrangement to optimize the system to produce electrical current from solar energy may be attained by changing the orientation of the rotor blades in a turbine configuration, but in some examples a panel configuration may be created by removing the blades from the rotor hub and/or nacelle and affixing some or all of the blades in a parallel alignment to form a panel that may be positioned in an orientation to optimize solar power generation. In other examples, the rotor blades may be removed from the rotor hub and/or nacelle and used individually or collectively to convert solar energy into electrical power without being grouped together in a panel configuration.

Systems and methods in accordance with the present invention may provide readily transportable and easily deployable power generation capabilities. Rotor blades may be formed of a lightweight material, such as fiberglass, carbon fibers, or a composite material, and at least partially covered with a photovoltaic film. In some examples in accordance with the present invention, at least a third or at least a half of the surface of a rotor blade is covered with a photovoltaic film. The length of the rotor blades and the size and weight of the gearbox and generator (both of which may be contained within a nacelle) may be selected to be of a size appropriate for the transportation available. For example, rotor blades of between two and three feet in length may provide a system small enough to be carried by a single individual (particularly when collapsed as described herein) that may generate approximately 300 watts of power. The power generation potential of a system may be increased (or decreased) by lengthening (or shortening) the rotor blades and/or increasing (or decreasing) the surface area covered by solar cells. If vehicular transportation of a system in accordance with the present invention is possible, the system may be larger yet. The actual power generated by a system may vary based upon wind speed, solar intensity, and deployment conditions such as the orientation of a turbine with the wind and the orientation of solar cells relative to incident sunlight.

### BRIEF DESCRIPTION OF THE SEVERAL VIEWS OF THE DRAWINGS

Examples of systems and methods in accordance with the present invention are described in conjunction with the attached drawings, wherein:

FIG. 1 illustrates a perspective view of an exemplary wind/solar electrical generation system in accordance with the present invention deployed as a wind turbine;

FIG. 2 illustrates a perspective view of an exemplary wind/solar electrical generation system in accordance with the present invention deployed as a solar panel;

FIG. 3 illustrates a perspective view of an exemplary wind/solar electrical generation system in accordance with the present invention configured for transportation or storage;

FIG. 4 illustrates a perspective view of an exemplary wind/solar electrical generation system in accordance with the present invention while carried by an individual;

FIG. 5 illustrates a schematic view of an exemplary wind/solar electrical generation system in accordance with the present invention deployed as a wind turbine;

FIG. 6 illustrates an exploded view of an example of the assembly of rotor blades to a rotor hub in an exemplary wind/solar electrical generation system in accordance with the present invention;

FIG. 7 illustrates an example of a rotor blade extending radially from a rotor hub in an exemplary wind/solar electrical generation system in accordance with the present invention;

FIG. 8 illustrates an example of a rotor blade affixed to a rotor hub in a folded position in an exemplary wind/solar electrical generation system in accordance with the present invention; and

FIG. 9 illustrates a further example of an exemplary wind/solar electrical generation system in accordance with the present invention deployed as a solar generator.

### DETAILED DESCRIPTION

The present invention provides systems and methods that may be used to generate electrical power from at least wind and solar inputs. In some examples, systems in accordance with the present invention may be configurable for optimal production of electrical power from wind in a first configuration, for optimal production of electrical power from the sun in a second configuration, and/or for optimal transportation or storage in a third configuration. In the first configuration, a plurality of rotor blades may extend radially from a rotor hub such that the rotor blades turn around an axis of rotation under the influence of an incident wind. The rotor hub may be turned around the axis of rotation by the rotating blades, and the rotating rotor hub may, in turn, transfer the rotational energy through a gearbox to an electrical generator. The rotor blades may be folded from the radially extended configuration to extend substantially parallel to the axis of rotation for storage or transport. In the second configuration optimized for generating electricity from solar power, the rotor blades may be oriented such that a photovoltaic film covering at least part of the surfaces of the rotor blades may receive sunlight.

In examples in accordance with the present invention, a rotor hub may be affixed to a generator such that the rotation of the rotor hub about an axis of rotation will cause the generator to produce an electrical current. A plurality of rotor blades may affixed to the rotor hub. The rotor blades may be hingedly and/or detachably affixed to the rotor hub to permit the rotor blades to be moved to different configurations for generation of electrical power from a wind input, for generation of electrical power from a solar input, and/or for transportation or storage. A hinge may detachably affix each of the plurality of rotor blades to the rotor hub, such that each hinge permits the affixed rotor blade to be placed in a first position extending radially from the rotor hub so that the plurality of rotor blades extending radially from the rotor hub will cause the rotor hub to rotate under the influence of an incident wind. Each hinge may further permit the affixed rotor blade to be placed in a second position extending roughly parallel to the axis of rotation caused by an incident wind when the rotor blades are radially extended. At least one pin may detachably secure each of the plurality of rotor blades in the first extended position, such that when the at least one pin is withdrawn the rotor blade may be moved to the second folded position. In some examples, a hinge pin and a locking pin may be removably inserted through a connection end of a rotor blade and a connection point on the rotor hub such that the rotor blade may hinged between an extended and a folded position when only the hinge pin is inserted and may be held in a radially extending position when both the hinge pin and the locking pin are inserted. At least one photovoltaic material, such as a photovoltaic film, may cover at least a portion of the surface of each of the plurality of rotor blades. At least one current controller may regulate the electrical current output by the generator and the photovoltaic material and may output generated electrical current for a user. A nacelle may enclose the generator and/or gearbox. When the rotor blades are placed in a folded configuration approximately parallel to the axis of rotation, the folded rotor blades may at least partially enclose the nacelle. A detachable or foldable pole may be affixed to the nacelle and used, optionally in combination with a plurality of guy-lines, to support the rotor hub and rotor blades at a height desired to generate electrical current from an incident wind. The detachable pole may telescope, collapse or be disassemblable to permit easy transport of the pole while being extendable to a length sufficient to raise the radially extending rotor blades to an altitude that permits them to rotate freely under the influence of an incident wind.

In further examples, the present invention may provide electrical generation systems that may generate electricity from wind and/or solar inputs. A system in accordance with the present invention may comprise a plurality of rotor blades at least partially covered with a photovoltaic film. Each of the plurality of rotor blades may have a length, and each of the plurality of rotor blades further have a terminal end that is distant from a rotor hub when placed in a radially extending configuration and an attachment end that may be affixed to the rotor hub. The rotor hub may have a plurality of attachment points that detachably receive an attachment end of each of the plurality of rotor blades. For each of the attachment points of the rotor hub, at least one hinge pin and at least one locking pin may be removably inserted to join the attachment end of the rotor blade to the attachment point of the rotor hub. Each of the at least one hinge pins may be insertable through the attachment end of one of the plurality of rotor blades and one of the plurality of attachment points to foldably secure one of the plurality of rotor blades to one of the attachment points. Each of the at least one locking pins may be insertable through the attachment end of one of the plurality of rotor blades and one of the plurality of attachment points to lock the rotor blade in a first position extending radially from the rotor hub for use in generating electricity from a wind incident upon the rotor blade. A nacelle may contain a generator that produces an electrical current when the rotor hub turns, the rotor hub turning under the influence of an incident wind when the plurality of rotor blades are affixed to the plurality of attachment points in the first position extending radially from the rotor hub when both a hinge pin and a locking pin have been inserted through the attachment end of the rotor blade and the attachment point of the rotor hub. At least one detachable electrical connection between the photovoltaic film covering each of the plurality of rotor blades may receive electrical current generated when solar light is incident upon the photovoltaic film. The current generated by the photovoltaic film(s) optionally may be combined with any current generated by the generator due to the rotation of the rotor blades, but in some examples electrical power may be generated from only a single source (wind or solar) at a given time. One or more diode may be used to prevent the photovoltaic film(s) from drawing an electrical current when insufficient sunlight is incident upon the film(s) to produce a net current. The plurality of rotor blades may be movable between a first position, a second position, and/or a third position. In the first position, the rotor blades may extend radially from the rotor hub to generate an electrical current from an incident wind. The rotor blades may be secured in the first position by inserting both the hinge pins and the locking pins through the attachment ends of rotor blades and corresponding attachment points of the rotor hub. In the second position, the rotor blades may be folded to enclose the nacelle when only the hinge pins are inserted through the attachment ends of rotor blades and corresponding attachment points of the rotor hub. In the third position, the rotor blades may be detached from the rotor hub and, optionally, retained in an arrangement exposing the photovoltaic films for use to generate electrical power from sunlight incident upon the rotor blades. A frame optionally may be used to retain the rotor blades in a parallel orientation in the third position. In the present example, the first position may be referred to as a wind turbine position, the second position may be referred to as a transport position, and the third position may be referred to as a solar panel position. A rod or pole may be used to support the nacelle, rotor blades, and rotor hub in the first position. While referred to as a first position, a second position, and a third position in the present example, more, fewer, or different positions than these may be used by electrical generation systems in accordance with the present invention.

In yet a further example, systems in accordance with the present invention may be configurable for the generation of electrical power from an incident wind, for the generation of electrical power from incident sunlight, and/or for transportation and/or storage of the system. A generator may be contained within a nacelle to produce an electric current from rotational motion caused by an incident wind. A rotor hub may be mechanically connected to the generator, for example through a gearbox. The rotor hub may extend from the front of the nacelle. A plurality of rotor blades, such as four rotor blades, may be detachably and hingedly affixed to the rotor hub. The rotor blades may have a first length. The rotor blades may be positionable in a first configuration wherein the rotor blades are affixed to the rotor hub and extend radially from the rotor hub such that the rotor blades and the rotor hub rotate under the influence of an incident wind to cause the generator to produce an electrical current. At least one photovoltaic film may be applied to a portion, such as at least a third or at least half, of the surface of each of the rotor blades. The rotor blades and the at least one photovoltaic film of each of the rotor blades may be positionable in a second configuration to receive incident solar light when detached from the rotor hub, although the photovoltaic film on one or more of the rotor blades may receive sunlight and produce an electrical current while in other configurations as well. The second configuration may be achieved by orienting the nacelle, rotor hub, and rotor blades to maximize incident sunlight and to optimize the angle of incidence, but in other examples the rotor blades may be detached from the rotor hub and placed into a second configuration comprising a parallel arrangement supported by a frame. While in the first configuration, a telescoping pole may support the nacelle, rotor hub, and rotor blades at a desired height for the generation of electricity from an incident wind. The telescoping pole may have a first end detachably affixable and/or foldably affixed to the nacelle and a second end insertable into the ground. In other examples, the second end of the pole may be affixable to buildings or vehicles. The telescoping pole may be extendable to a length exceeding the first length of the rotor blades, such that when the second end of the telescoping pole is inserted into the ground or otherwise affixed and the first end of the telescoping pole is detachably affixed to the nacelle the telescoping pole supports the nacelle, rotor hub, and rotor blades such that the rotor blades are free to rotate under the influence of an incident wind without contacting the ground. A plurality of guy-lines extending from the telescoping pole to the ground may maintain the telescoping pole in a vertical orientation when the telescoping pole is supporting the nacelle, rotor hub, and rotor blades in the first configuration above the ground. In the present example the rotor blades may be further placed in a third configuration wherein the rotor blades are folded to at least partially enclose the nacelle. Such a third configuration may be useful for transporting and/or storing a system in accordance with the present invention. In the present example, the first configuration may be referred to as a wind turbine configuration, the second configuration may be referred to as a solar panel configuration, and the third configuration may be referred to as a transport configuration. While referred to as a first configuration, a second configuration, and a third configuration in the present example, more, fewer, or different configurations than these may be used by electrical generation systems in accordance with the present invention.

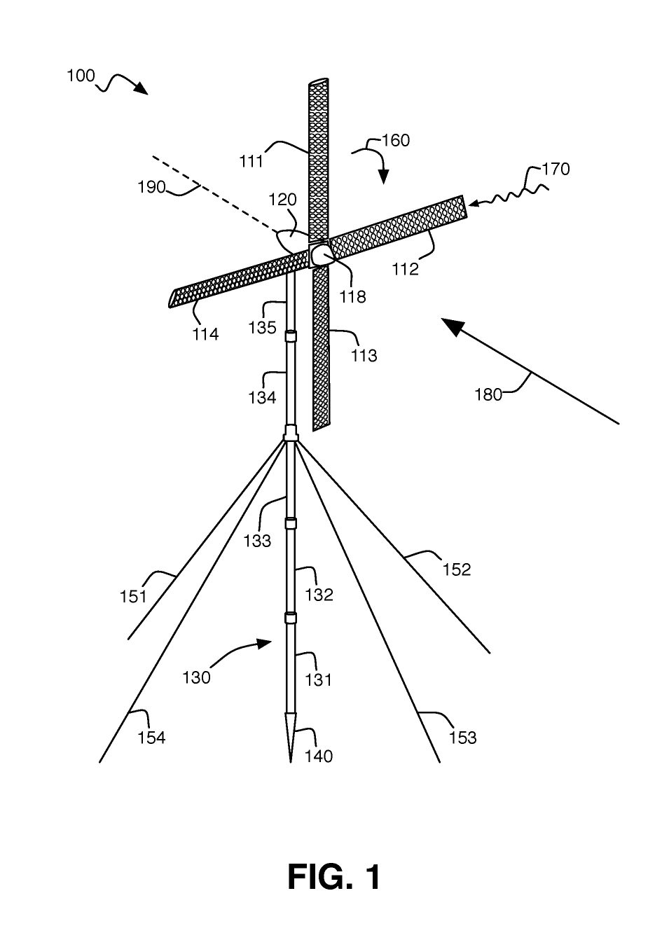

FIG. 1 illustrates an example of a system 100 in accordance with the present invention in a turbine configuration. Any number of rotor blades may be provided to capture wind energy, but the example of FIG. 1 depicts an example with four rotor blades. A first blade 111, a second blade 112, a third blade 113, and a fourth blade 114 may be affixed to a rotor hub 118. Rotor blades 111, 112, 113, 114 may be detachably and/or hingedly affixed to rotor hub 118 to permit them to be configured in ways other than the turbine configuration depicted in FIG. 1.

Rotor blades 111, 112, 113, 114 may have a pitch angle to enable them to rotate 160 about an axis of rotation 190 in response to wind 180 incident upon the blades 111, 112, 113, 114. Rotor blades 111, 112, 113, 114 may also have an airfoil shape. A nacelle 120 may contain a gearbox and generator to produce an electrical current when the rotor blades 111, 112, 113, 114 spin. Electrical components to output the generated electrical current, whether produced by a wind or solar input, may also be enclosed within nacelle. All or part of the surface of all or some of the rotor blades 111, 112, 113, 114 may be covered with a photovoltaic material that produces an electrical current when sunlight 170 is incident upon the surface. Photovoltaic material may additionally/alternatively be provided upon other surfaces of system 100, such as upon the nacelle 120 and/or a pole 130 or other structure that supports the turbine.

System 100 may utilize various mechanisms to maintain nacelle 120 and rotor blades 111, 112, 113, 114 at a height that permits blades to spin 160 and, optionally, to improve the consistency and/or strength of the wind encountered by blades 111, 112, 113, 114. The example depicted in FIG. 1 uses a telescoping pole 130 to elevate the nacelle 120 and rotor blades 111, 112, 113, 114, but other configurations and/or structures may be used. A telescoping pole 130 may collapse within itself to provide convenient transport of a system 100 in a different configuration, some of which are described further herein. A telescoping pole 130 may be detachably or foldably affixed to nacelle 120. Telescoping pole 130 may comprise any number of components. In the example of FIG. 1, telescoping pole 130 comprises a first component 131, a second component 132, a third component 133, a fourth component 134, and a fifth component 135 of essentially equal lengths that collapse within one another to permit the entire pole 130 to be contained within a single component, such as first component 131. In some examples, a single component of telescoping pole 130 may have a length approximately equal to or less than the length of the rotor blades 111, 112, 113, 114 while the fully extended pole 130 may have a length exceeding the length of the rotor blades 111, 112, 113, 114. A terminal end 140 may be provided to facilitate securing the pole 130 to the ground or other surface to deploy system 100. Terminal end 140 may be on the end of pole 130 opposite of nacelle 120. In the example of FIG. 1, terminal end 140 has a pronounced point to enable it to be driven or pushed into the ground, but other configurations are possible. For example, a terminal end 140 may be adapted to affix a system 100 to a manmade object or structure, such as a vehicle, building, platform, or other object. In other examples, rather than using a telescoping pole 130 to support nacelle 120 and rotor blades 111, 112, 113, 114, other structures may be used to support the system at a desired height. For example, any pole or rod, such as may be fashioned from resources such as timber available in some environments, may be used instead of a telescoping pole 130. In other examples, rather than telescoping, a provided pole may comprise a number of shorter segments that may be disassembled and reassembled using mechanisms such as threaded components to permit the pole to attain a sufficient length while being able to be reduced to component parts short enough for easy transport and/or storage.

A pole may be braced in a variety of ways to permit it to withstand the incident winds used to generate electrical power. In the example of FIG. 1, a plurality of guy-lines are illustrated, such as a first guy-line 151, a second guy-line 152, a third guy-line 153, and a fourth guy-line 154. Guy-lines 151, 152, 153, 154 may be wires, cables, ropes, etc., but additionally/alternatively may be rigid poles, boards, etc. More or fewer guy-lines 151, 152, 153, 154 than illustrated in the example of FIG. 1 may be used. If terminal end 140 may be affixed securely enough to withstand wind conditions, guy-lines 151, 152, 153, 154 may be omitted entirely. Other mechanisms for erecting system 100 in a turbine configuration may require neither a pole 130 or guy-lines 151, 152, 153, 154, for example if system 100 is affixed to a pre-existing structure.

The example system 100 illustrated in FIG. 1 employs a rotor that is downwind of the nacelle 120. The end of telescoping pole 130 that is affixed to nacelle 120 may be hinged or detachable to permit a reconfiguration of system 100, such as described herein. The end of telescoping pole 130 that is affixed to nacelle 120 may also permit nacelle 120 to rotate while in the turbine configuration depicted in FIG. 1 in order to permit the nacelle 120 to spin in a plane substantially parallel to the ground such that the rotor blades 111, 112, 113, 114 may face the wind from any direction. Such a rotatable joint may use a yaw bearing or a bushing. The nacelle 120 may be coupled in other ways to generate a yawing torque to provide a passive yaw mechanism, so that the rotor will automatically face the wind as it changes direction.

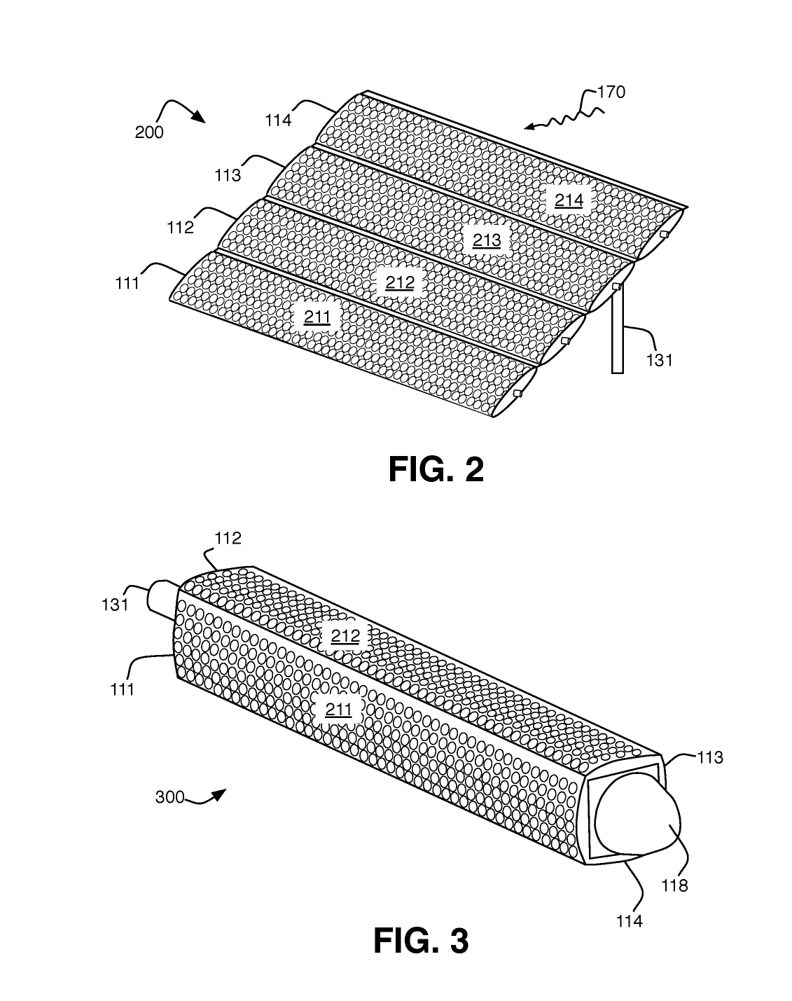

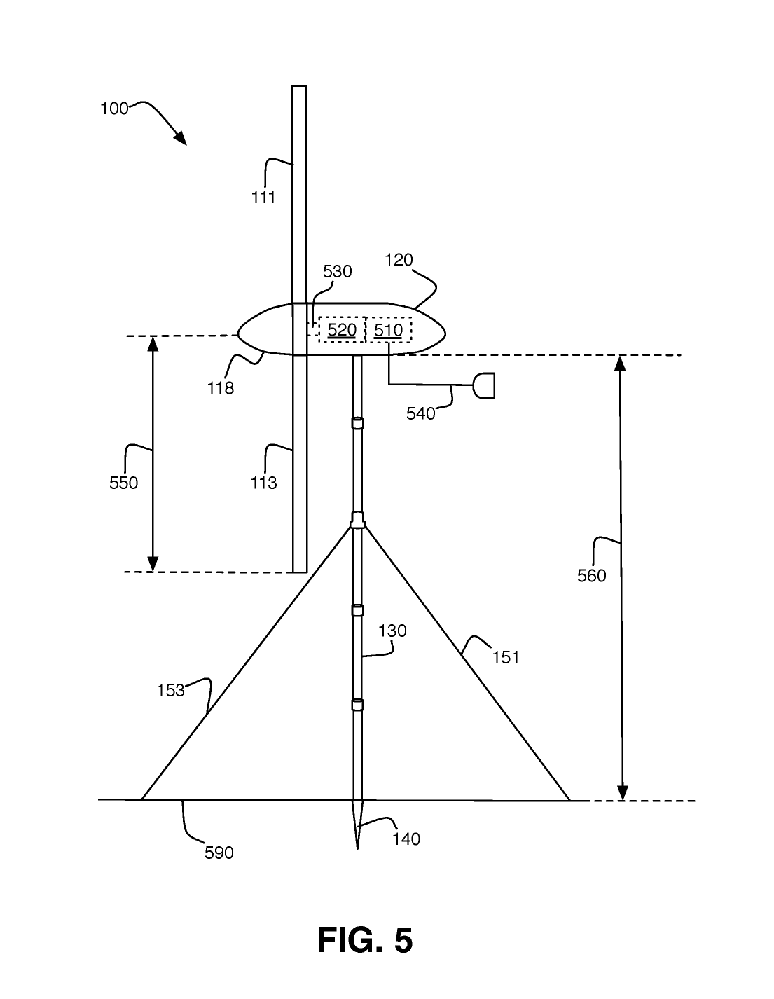

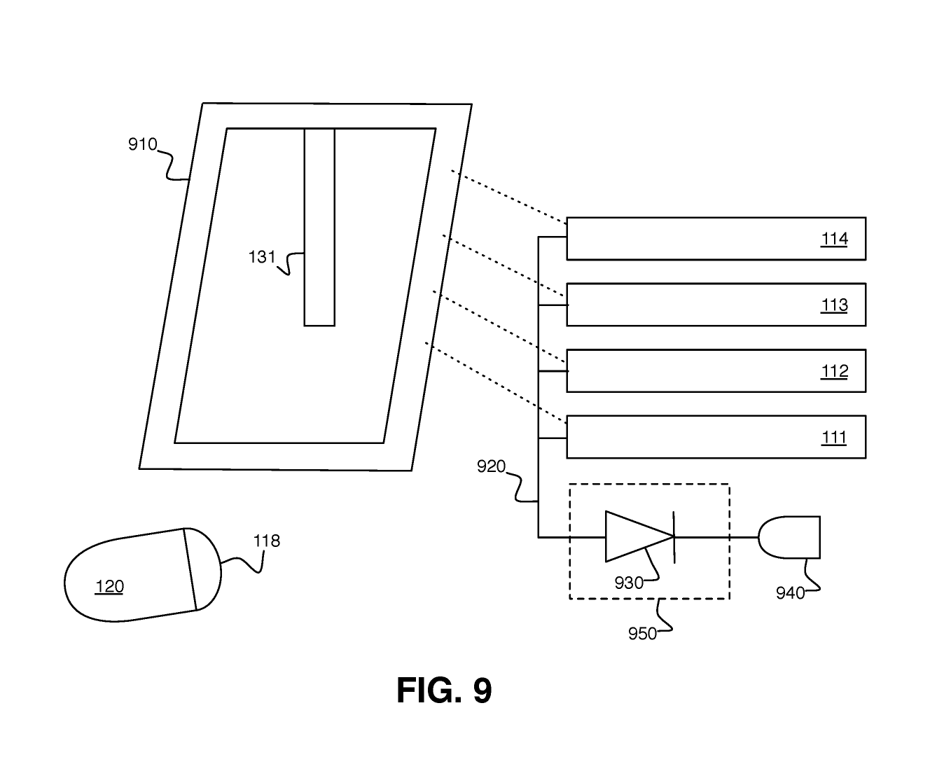

FIG. 5 depicts further aspects of an example system 100 in accordance with the present invention deployed in a wind turbine configuration. As can be seen, a pointed end 140 of pole 130 has been driven into the ground 590. Pole 130 and guy-lines 151, 153 (potentially as well as the additional guy-lines depicted in the example of FIG. 1) hold nacelle 120 at a desired height 560 determined by the length of the pole 130 sufficiently greater than the length 550 of the rotor blades 111, 112, 113, 114 to permit the rotor blades and rotor hub 118 to rotate under the influence of an incident wind. The length of pole 130 may further retain the rotor blades 111, 112, 113, 114 at a height 560 sufficient to elevate the turbine assembly above turbulence induced by the ground and terrestrial features. The rotation of the rotor blades 111, 112, 113, 114 due to the incident wind may be transmitted to rotor hub 118 and then by a shaft 530 through a gearbox 520 to a generator 510 that produces an electrical current transmitted to a user or a user's electrical device via an electrical connection 540. Electrical connection 540 may be incorporated into other elements of system 100, such as pole 130, for the convenience of a user. Further, electrical connection 540 may comprise additional elements to combine electrical currents produced by generator 510 and photovoltaic films provided on the rotor blades 111, 112, 113, 114 and/or elsewhere on the system 100. Electrical connection 540 may further provide one or more diode to prevent a photovoltaic film from drawing an electrical current. Electrical connection 540 may be incorporated into the pole 130, into one or more of the guy-lines 151, 152, 153, 154, or may be provided as a separate component. The same or a different electrical connection may be used to output power produced in a configuration such as described below with regard to FIGS. 2 and 9.

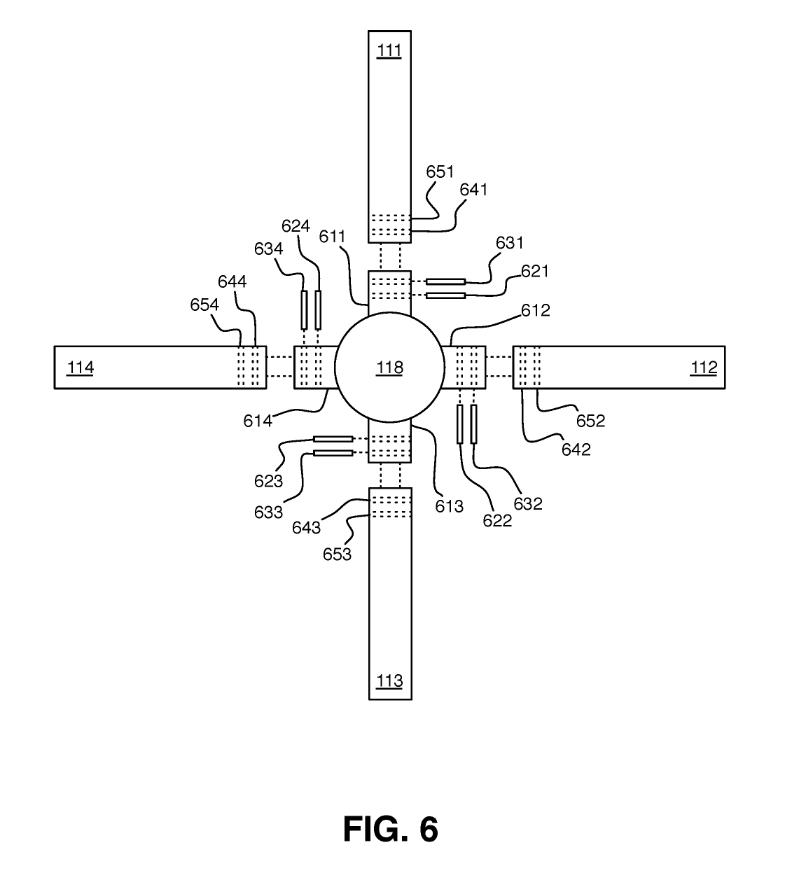

FIG. 6 illustrates one example of how a plurality of rotor blades 111, 112, 113, 114 may be hingedly and/or detachably affixed to a rotor hub 118 in accordance with the present invention. Each of rotor blades 111, 112, 113, 114 may have two ends. A terminal end may be the end of the rotor blade most distant from the rotor hub 118 when the system is assembled, while an attachment end may be adjacent to the rotor hub 118 when the system is assembled. The attachment end of each of the rotor blades 111, 112, 113, 114 may be affixable to one of a plurality of attachment points 611, 612, 613, 614 provided on rotor hub 118. Attachment points 611, 612, 613, 614 may be formed integrally with or rigidly affixed to rotor hub 118 in order to transmit rotational energy from an attached rotor blade 111, 112, 113, 114 to rotor hub 118. While a variety of mechanisms may be used to join rotor blades 111, 112, 113, 114 to connection points 611, 612, 613, 614, one exemplary structure that may be used to detachably and hingedly attach a rotor blade to an attachment point is a pair of pins that may be inserted through aligned holes provided in the attachment end of a rotor blade and in an attachment point. For example, an attachment end of a rotor blade may comprise a channel that mates with a rectangular or channel structure of connection point, in which case the connection point may slide within the attachment end or vice-versa. If only one of the two pins are inserted, the rotor blade may be hinged about the inserted pin, but if both pins are inserted the rotor blade may be secured to extend radially from the rotor hub 118 in a turbine configuration. For example, a hinge pin 631 may be removably inserted into a hinge hole 651 and a locking pin 621 may be removably inserted into a locking hole 641 to secure first rotor blade 111 to first connection point 641. Similarly, a hinge pin 632 may be removably inserted into a hinge hole 652 and a locking pin 622 may be removably inserted into a locking hole 642 to secure second rotor blade 112 to second connection point 642; a hinge pin 633 may be removably inserted into a hinge hole 653 and a locking pin 623 may be removably inserted into a locking hole 643 to secure third rotor blade 113 to third connection point 643; and a hinge pin 634 may be removably inserted into a hinge hole 654 and a locking pin 624 may be removably inserted into a locking hole 644 to secure fourth rotor blade 114 to fourth connection point 644. Of course, more or fewer rotor blades and connection points than the four depicted in the example of FIG. 6 may be used, as may differing numbers of hinge pins and/or locking pins. While in the present example a single locking pin is used in conjunction with a single hinge pin, other configurations may be used. For example, multiple locking pins may be used to provide greater rigidity for the assembled system. By way of further example, the function of a hinge pin(s) and/or a locking pin(s) may be served using other structures, such as components molded into the attachment end of a rotor blade and/or a connection point of a rotor hub.

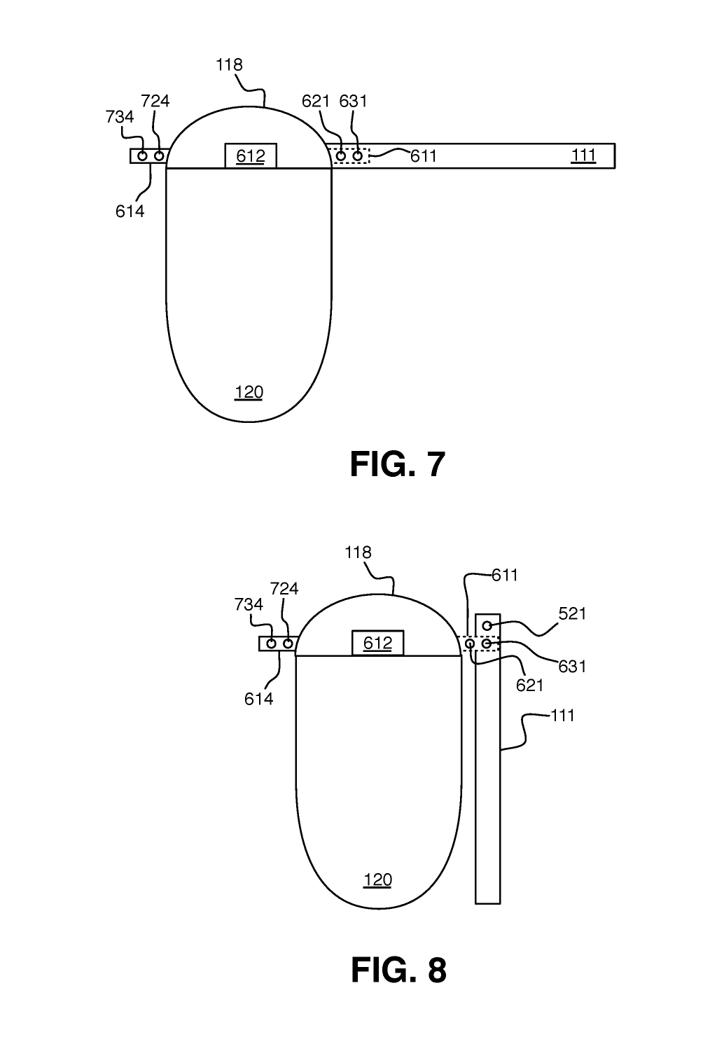

FIG. 7 depicts a single rotor blade 111 assembled to a single connection point 611 using a hinge pin 631 and a locking pin 621, while other connection points 612, 614 have not yet received a corresponding rotor blade. As can be seen in FIG. 7, holes such as holes 724, 734 may be provided in each connection point to receive pins to affix a rotor blade to a connection point. FIG. 8 depicts the configuration resulting if locking pin 621 is removed from the assembly depicted in FIG. 7. As can be seen in FIG. 8, rotor blade 111 has hinged about hinge pin 631 to fold against nacelle 120. When folded against nacelle 120, rotor blade 111 is substantially parallel to the axis about which rotor hub 118 rotates when the system is in use as a wind turbine.

While the configuration of system 100 depicted in FIGS. 1 and 5 may generate electricity from both wind and solar energy simultaneously (or may generate power from only wind energy if insufficient sunlight is incident upon the solar cells or if the electrical current from solar energy is not combined with the current produced using wind energy), in some circumstances generating power from only solar energy may be preferred. For example, wind speeds may be too low or too high for sustained generation of electricity using wind energy, while incident sunlight may be relatively abundant. In such a scenario, the system 100 may be configured as depicted in FIG. 2 to maximize solar energy capture.

As shown in the example of FIGS. 2 and 9, the rotor blades 111, 112, 113, 114 may be detached from the rotor hub 118 and arranged to create a panel assembly 200 that presents a photovoltaic surface substantially perpendicular to incident sunlight 170. The configuration depicted in FIG. 2 permits a first photovoltaic film 211 applied to at least one surface of the first blade 111, a second photovoltaic film 212 applied to at least one surface of the second blade 112, a third photovoltaic film 213 applied to at least one surface of the third blade 113, and a fourth photovoltaic film 214 applied to at least one surface of the fourth blade 114 to be oriented to maximize their capability to receive sunlight 170. The blades 111, 112, 113, 114 may be affixed together (for example, using a frame, clips or material provided to transport the system in a bundled configuration) to form a panel assembly 200 supported (for example, by using a first portion 131 of telescoping pole 130) to maintain the photovoltaic films 211, 212, 213, 214 in an orientation substantially perpendicular to incident sunlight 170. The photovoltaic films 211, 212, 213, 214 may be applied to the front and/or rear sides (as defined by the wind turbine configuration) of the rotor blades 111, 112, 113, 114, and need not be applied to the entire surface of the rotor blades 111, 112, 113, 114. In some examples, at least a third of the surface of the rotor blades 111, 112, 113, 114 are covered by a photovoltaic film 211, 212, 213, 214, while in other examples at least a half of the surface of the rotor blades 111, 112, 113, 114 are covered by a photovoltaic film 211, 212, 213, 214.

The contours of the rotor blades 111, 112, 113, 114 that aerodynamically permit them to efficiently spin in the wind while affixed in the wind turbine configuration depicted in FIG. 1 may typically prevent the entirety of a surface covered by a photovoltaic film 211, 212, 213, 214 to be perfectly perpendicular to incident sunlight 170, but by departing from the substantially vertical orientation of rotor blades 111, 112, 113, 114 shown in FIG. 1, the efficiency of solar energy production may be increased. The orientation of the panel 200 assembled from rotor blades 111, 112, 113, 114 may be adjusted by moving the panel relative to pole 131 or other support mechanisms. The nacelle 120 may likewise be used to support the panel assembly 200. The nacelle 120 may additionally/alternatively provide electrical components for use in provided electricity generated by the solar panel assembly 200, such as (for example) one or more diodes to prevent the photovoltaic films 211, 212, 213, 214 from drawing an electrical current when they are not generating sufficient current from incident sunlight 170, as may occur after sundown, during cloudy conditions, or due to sun movement during the day.

As shown more specifically in FIG. 9, a frame 910 may retain the rotor blades 111, 112, 113, 114 in a position and in an orientation for optimal generation of electricity from a solar input. An electrical connection 940 (which may optionally be the same electrical connection 540 depicted in the example of FIG. 5) may provide electrical components 950 to combine electrical currents, and may further provide at least one diode 930 to prevent the photovoltaics from drawing electrical current when not producing a net positive electrical current due to incident sunlight.

Referring now to FIG. 3, a bundled configuration 300 of a system in accordance with the present invention is illustrated. Each rotor blade 111, 112, 113, 114 has been folded back from the rotor hub 118 to at least partially enclose the nacelle 120 (obscured by the blades 111, 112, 113, 114 in the configuration depicted in the example of FIG. 3). A hinge and pin system may be used to permit the blades to be affixed in an extended position (as depicted in FIGS. 1 and 5) or affixed in a bundled position (as illustrated in FIG. 3), while a bracket or frame retaining rotor blades 111, 112, 113, 114 may permit them to be removed from rotor hub 118 entirely to be assembled in the panel configuration 200 depicted in FIGS. 2 and 9. While various configurations and dimensions of components may be used in accordance with the present invention, in the example of FIG. 3 the relative sizes of the components exposes the nose of rotor hub 118 and a portion 131 of pole 130 while the system is in a bundled configuration, but the nacelle 120 is enclosed within rotor blades 111, 112, 113, 114 to form a box-like structure having a length of approximately the length of a rotor blade 111, 112, 113, 114 and a width and height of approximately the breadth of a rotor blade 111, 112, 113, 114. Clips or straps may be used to retain rotor blades 111, 112, 113, 114 in the folded configuration illustrated in the example of FIG. 3, and those clips or straps may be used to retain the rotor blades 111, 112, 113, 114 in the panel configuration 200 illustrated in FIG. 2. In other examples, a bag, box, or other structure may be used to retain the rotor blades 111, 112, 113, 114 in the folded position of the bundled configuration. The resulting bundle 300 may be more easily transported than the wind turbine configuration 100 depicted in the example of FIG. 1 or the panel configuration 200 depicted in FIG. 2.

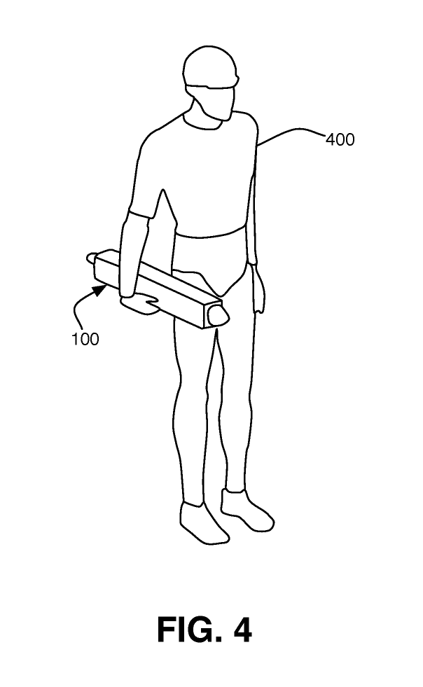

The transport of a system in accordance with the present invention while in a bundled configuration 300 is depicted in FIG. 4. As a result of using rotor blades 111, 112, 113, 114 with a length and breadth that results in bundle 300 to have overall dimensions that can be carried by a single individual 400, a system in accordance with the present invention may be easily transported. For example, a rotor blade length in the range of one to four feet in some examples, or in the range of two to three feet in other examples, may provide sufficient power generation capabilities but still result in a bundle 300 that can be handled by a single individual 400. Similarly, a rotor blade breadth in the range of four to ten inches may provide sufficient power generation capabilities while still resulting in a bundle 300 small enough to be transported by an individual 400.

Materials used for constructing components of a system in accordance with the present invention may be selected to be lightweight for easy transportation but resilient for use. Rotor blades, for example, may be formed of fiberglass, carbon fibers, composite materials, foams, aluminum, other light and resilient materials, or a combination of the above materials. In some examples, strength and/or rigidity may be provided by a framework of relatively heavy material in combination with one or more lighter material. The housing(s) for the rotor hub and/or nacelle may be formed from fiberglass, carbon fibers, composite materials, aluminum, or other materials that are light, rigid, and durable. Mechanical components, such as the gearbox and/or generator used to generate an electrical current during use as a turbine, may be formed of various metal alloys, carbon fibers, or composites. A variety of photovoltaic films may be used for the generation of electrical current in systems in accordance with the present inventions, such as (but not limited to) copper indium gallium selenide and/or sulphur (CIGS) films; amorphous silicon (a-Si) films; cadmium telluride (CdTe) films, dye-sensitized solar cell (DSSC) films, and/or any other type of solar cell or photovoltaic material. In some examples, crystalline silicon solar cells may be used in accordance with the present invention.

Systems in accordance with the present invention may further provide straps, cases, bags, boxes, crates, and/or other elements to facilitate transport while in a bundled configuration. Such elements may be used in other aspects of the present invention, such as in anchoring a system in a turbine configuration, orienting a system in a panel configuration, or maintaining components (such as rotor blades) in a given configuration. For example, a resilient and pliable membrane or textile may be used to contain the system in a bundled configuration and may also be used to retain the rotor blades in a panel configuration.

1. A system for generating electrical power, the system comprising:
a rotor hub affixed to a generator such that the rotation of the rotor hub about an axis of rotation will cause the generator to produce an electrical current;
a plurality of rotor blades affixed to the rotor hub;
a hinge affixing each of the plurality of rotor blades to the rotor hub, each hinge permitting the affixed rotor blade to be placed in a first position extending radially from the rotor hub such that when each of the plurality of rotor blades extend radially the rotor blades will cause the rotor hub to rotate around the axis of rotation under the influence of an incident wind, each hinge further permitting the affixed rotor blade to be placed in a second position extending roughly parallel to the axis of rotation;
at least one pin that detachably secures each of the plurality of rotor blades in the first extended position, such that when the at least one pin is withdrawn the rotor blade may be moved to the second folded position;
at least one photovoltaic material covering at least half of the surface of each of the plurality of rotor blades; and
at least one current controller that regulates the electrical current output by the generator and the photovoltaic material.

2. The system for generating electrical power of claim 1, further comprising a nacelle that encloses the generator, and wherein the rotor blades enclose the nacelle on four sides when the rotor blades are placed in the second folded position.

3. The system for generating electrical power of claim 2, further comprising a detachable pole that extends from a bottom surface of the nacelle to support the nacelle above a surface when the system is deployed to generate electrical current using wind, the detachable pole having a length greater than the length of the rotor blades.

4. The system for generating electrical power of claim 3, wherein the photovoltaic material is one of a copper indium gallium selenide and/or sulphur (CIGS) film, an amorphous silicon (a-Si) film, a cadmium telluride (CdTe) film, and a dye-sensitized solar cell (DSSC) film.

5. A system for generating electrical power from wind and/or solar inputs, the system comprising:
a plurality of rotor blades at least partially covered with a photovoltaic film, each of the plurality of rotor blades having a length, each of the plurality of rotor blades further having a terminal end and an attachment end;
a rotor hub having a plurality of attachment points that detachably receive each of the plurality of rotor blades;
for each of the attachment points of the rotor hub, at least one hinge pin and at least one locking pin, each of the at least one hinge pins insertable through the attachment end of one of the plurality of rotor blades and one of the plurality of attachment points to foldably secure one of the plurality of rotor blades to one of the attachment points, and each of the at least one locking pins insertable through the attachment end of one of the plurality of rotor blades and one of the plurality of attachment points to lock the rotor blade in a first position extending radially from the rotor hub;
a nacelle containing a generator that produces an electrical current when the rotor hub turns, the rotor hub turning under the influence of an incident wind when the plurality of rotor blades are affixed to the plurality of attachment points in the first position extending radially from the rotor hub when both a hinge pin and a locking pin have been inserted through the attachment end of the rotor blade and the attachment point of the rotor hub;
at least one detachable electrical connection between the photovoltaic film covering each of the plurality of rotor blades, the at least one detachable electrical connection receiving electrical current generated when solar light is incident upon the photovoltaic film; and
wherein the plurality of rotor blades are movable between a first position extending radially from the rotor hub to generate an electrical current from an incident wind by inserting both the hinge pins and the locking pins through the attachment ends of rotor blades and corresponding attachment points of the rotor hub, a second position folded to enclose the nacelle when only the hinge pins are inserted through the attachment ends of rotor blades and corresponding attachment points of the rotor hub, and at least a third position detached from the rotor hub.

6. The system for generating electrical power from wind and/or solar inputs of claim 5, further comprising a frame that detachably retains each of the plurality of rotor blades in a parallel arrangement when each of the plurality of rotor blades are detached from the plurality of attachment points of the rotor hub, the frame positionable to orient the photovoltaic film relative to solar light.

7. The system for generating electrical power from wind and/or solar inputs of claim 5, further comprising a pole detachably affixed to the nacelle at a first end and having an attachment mechanism at a second end, the pole retaining the nacelle and rotor blades in the first position wherein the rotor blades extend radially from the rotor hub for the generation of electrical power from incident wind.

8. The system for generating electrical power from wind and/or solar inputs of claim 7, wherein the attachment mechanism at the second end of the pole comprises a point that may be driven into the ground.

9. The system for generating electrical power from wind and/or solar inputs of claim 8, further comprising a plurality of guy-lines that retain the pole in a vertical orientation retaining the nacelle at a height above the ground exceeding the length of the plurality of rotor blades.

10. The system for generating electrical power from wind and/or solar inputs of claim 7, wherein the attachment mechanism at the second end of the pole comprises an interface with a man-made structure.

11. The system for generating electrical power from wind and/or solar inputs of claim 7, further comprising a combined electrical output that provides an electrical current from the generator and the photovoltaic film for use by a user.

12. The system for generating electrical power from wind and/or solar inputs of claim 11, further comprising at least one diode that prevents the photovoltaic film from drawing an electrical current.

13. A system for generating electrical power from multiple configurations, the system comprising:
a generator contained within a nacelle, a rotor hub mechanically connected to the generator and extending from the front of the nacelle, and four rotor blades having a first length and positionable in a first configuration wherein the four rotor blades are affixed to the rotor hub and extend radially from the rotor hub such that the rotor blades and the rotor hub rotate under the influence of an incident wind to cause the generator to produce an electrical current; and
at least one photovoltaic film applied to at least half of the surface of each of the four rotor blades, the at least one photovoltaic film of each of the four rotor blades positionable in a second configuration to receive incident solar light when detached from the rotor hub.

14. The system for generating electrical power from multiple configurations of claim 13, further comprising four detachable hinges connecting the four rotor blades to the rotor hub, the detachable hinges permitting the four rotor blades to be folded from the first configuration to a third configuration wherein the rotor blades enclose the nacelle on four sides for transport of the system.

15. The system for generating electrical power from multiple configurations of claim 14, further comprising:
a telescoping pole, the telescoping pole having a first end detachably affixable to the nacelle and a second end insertable into the ground, the telescoping pole extendable to a length exceeding the first length of the four rotor blades, such that when the second end of the telescoping pole is inserted into the ground and the first end of the telescoping pole is detachably affixed to the nacelle the telescoping pole supports the nacelle, rotor hub, and rotor blades such that the rotor blades are free to rotate under the influence of an incident wind without contacting the ground; and
a plurality of guy-lines extending from the telescoping pole to the ground that maintain the telescoping pole in a vertical orientation when the telescoping pole is supporting the nacelle, rotor hub, and rotor blades above the ground.

16. The system for generating electrical power from multiple configurations of claim 13, further comprising a frame that removably retains the four rotor blades in a parallel arrangement with the at least one photovoltaic film of each of the four rotor blades oriented to receive sunlight.
